(19) United States
(12) Patent Application Publication
(10) Pub. No.: US 2013/0329198 A1
(43) Pub. Date: Dec. 12, 2013

(54) PROJECTION OPTICAL APPARATUS AND IMAGE PROJECTION APPARATUS

(71) Applicant: Toshinobu MATSUYAMA, Kanagawa (JP)

(72) Inventor: Toshinobu MATSUYAMA, Kanagawa (JP)

(21) Appl. No.: 13/897,521

(22) Filed: May 20, 2013

(30) Foreign Application Priority Data
Jun. 11, 2012 (JP) 2012-131690

(51) Int. Cl. G02B 5/20; G03B 21/14

(52) U.S. Cl. CPC G02B 5/208; G03B 21/14
USPC 353/97; 359/350; 359/361

(57) ABSTRACT

A projection optical apparatus projects an image generated by an image generator onto a projection face by passing the image through a plurality of optical elements and an exit window. The projection optical apparatus includes an invisible-light reduction device to cut invisible light. The invisible-light reduction device prevents intrusion of the invisible light into the projection optical apparatus.

### CROSS-REFERENCE TO RELATED APPLICATION

This application claims priority pursuant to 35 U.S.C. §119 to Japanese Patent Application No. 2012-131690, filed on Jun. 11, 2012 in the Japan Patent Office, the disclosure of which is incorporated by reference herein in its entirety.

### BACKGROUND

1. Technical Field

The present invention relates to a projection optical apparatus and an image projection apparatus.

2. Background Art

Image projection apparatuses such as projectors can receive image data from personal computers or video cameras to generate an image using an image generator. A projection optical apparatus including a plurality of optical elements such as lenses and mirrors made of transparent material such as glass projects and displays the image onto a screen using light emitted from a light source through an exit window.

As disclosed in JP-2008-165202-A, the exit window is attached to an opening of the projection optical apparatus, wherein the exit window is made as small as possible while not blocking light projected from the image projection apparatus.

In the image projection apparatus, light from outside, such as sunlight enters the image projection apparatus through the exit window. The light entering from the exit window may strike internal parts such as a holder that retains optical elements of the projection optical apparatus. When the internal parts are irradiated by outside light, ultraviolet (UV) rays included in the outside light may degrade the internal parts, and infrared (IR) rays included in the outside light may heat and deform the internal parts.

In JP-2008-165202-A, the amount of outside light entering the image projection apparatus can be reduced by making the opening for the exit window as small as possible, by which the effect of invisible light from outside such as IR rays and UV rays on the internal parts can be suppressed.

However, the amount of outside light entering from the exit window may not be effectively reduced just by making the opening smaller, and thus the effect of invisible light from outside on the internal parts cannot be effectively suppressed.

### SUMMARY

In one aspect of the present invention, a projection optical apparatus is devised. The projection optical apparatus projects an image generated by an image generator by passing the image through a plurality of optical elements and an exit window of an image projection apparatus. The projection optical apparatus includes an invisible-light reduction device to cut invisible light. The invisible-light reduction device prevents intrusion of the invisible light into the projection optical apparatus.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 shows a perspective view of a projector according to an example embodiment and a projection plane;

FIG. 2 shows a pattern of light paths from a projector to a projection plane;

FIG. 3 shows a schematic perspective view of a projector;

FIG. 4 shows a perspective view of a main unit of a projector;

FIG. 5 shows a perspective view of an image generation unit;

FIG. 6 shows a schematic perspective view of a light source unit;

FIG. 7 shows a perspective view of an image generation unit and a lighting unit;

FIG. 8 shows a perspective view of the image generation unit of FIG. 7;

FIG. 9 shows a perspective view of a first optical unit with the lighting unit and the image generation unit;

FIG. 10 shows a cross-sectional view along a line D-D of FIG. 9;

FIG. 11 shows a perspective view of a second optical unit configured with a projection lens unit, the lighting unit, and the image generation unit;

FIG. 12 shows a perspective view of the second optical unit configured with the first optical unit, the lighting unit, and the image generation unit;

FIG. 13 shows a schematic view of the light path from the first optical system to a projection plane;

FIG. 14 schematically shows a layout of units in the projector;

FIG. 15 shows an example of use environment of the projector according to an example embodiment;

FIG. 16 shows an example of use environment of a conventional projector;

FIG. 17 shows another example of use environment of a conventional projector;

FIG. 18 shows an example of another use environment of the projector according to an example embodiment;

FIG. 19 shows a perspective view of the projector viewed from a bottom face of the projector;

FIG. 20 shows a perspective view of the projector when an openably closable cover is removed from the projector;

FIG. 21 shows a schematic view of airflow patterns in the projector;

FIG. 22 shows a view when a projector is placed near a window;

FIG. 23 shows an example of a light path of a light intruding inside a projector from outside;

FIG. 24 shows a schematic configuration around a transparent glass of a projector of a first example embodiment;

FIG. 25 shows another schematic configuration around a transparent glass of a projector of a first example embodiment;

FIG. 26 shows a schematic configuration around a transparent glass of a projector of a second example embodiment;

FIGS. 27A and 27B are schematic views illustrating a movement of a shutter viewed from a reflection mirror; and

FIG. 28 is a flowchart of a process of controlling a movement of a shutter.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that have the same function, operate in a similar manner and achieve a similar result. Referring now to the drawings, an apparatus or system according to an example embodiment is described hereinafter.

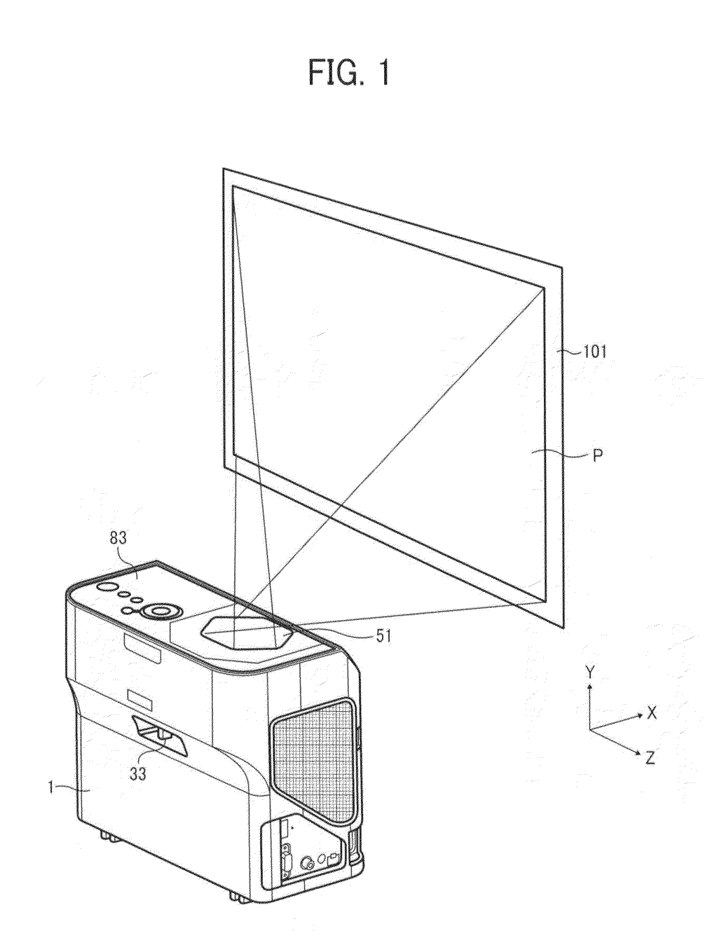

FIG. 1 shows a perspective view of a projector 1 and a projection plane 101. The projector 1 includes, for example, a transparent glass 51, an operation unit 83, and a focus lever 33. As shown in FIG. 1, the projector 1 has the transparent glass 51 on its top face, from which a projected image P is projected to the projection plane 101. The projected image P projected from the transparent glass 51 is displayed on the projection plane 101 such as a screen. Further, the projector 1 has the operation unit 83 on its top face, by which a user can operate the projector 1. Further, the projector 1 has the focus lever 33 on its side face for adjusting the focus of image. Hereinafter, the normal line direction of the projection plane 101 is set as X direction, the short side direction of the projection plane 101 (or top/bottom direction) is set as Y direction, and the long side direction of the projection plane 101 (or horizontal direction) is set as Z direction.

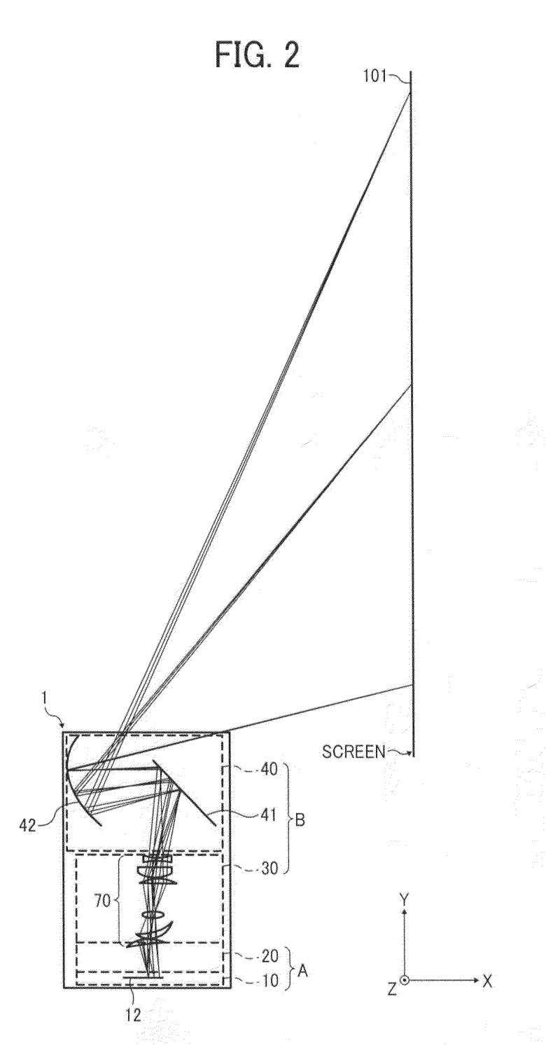

FIG. 2 shows a pattern of light paths from the projector 1 to the projection plane 101. The projector 1 includes, for example, a light source unit having a light source, and an image generator A to generate images using the light emitted from the light source. The image generator A includes, for example, an image generation unit 10, and a lighting unit 20. The projector 1 further includes a projection optical system B used as a projection optical apparatus.

The image generation unit 10 includes an image generation element such as a digital mirror device (DMD) 12. The lighting unit 20 reflects and radiates light coming from the light source to the DMD 12 to generate an image light. The projection optical system B projects the image light on the projection plane 101. The projection optical system B includes at least one pass-through type reflection optical system. For example, the projection optical system B includes a first optical unit 30 and a second optical unit 40. The first optical unit 30 includes, for example, a first optical system 70 of a co-axial system having a positive power. The second optical unit 40 includes, for example, a reflection mirror 41, and a curved mirror 42 having a positive power.

The DMD 12 can generate an image using the light emitted from the light source. Specifically, the light emitted from the light source radiates the DMD 12 and an image is generated by modulating the light radiated by the lighting unit 20. The image generated by the DMD 12 is projected onto the projection plane 101 via the first optical system 70 of the first optical unit 30, and the reflection mirror 41 and the curved mirror 42 of the second optical unit 40.

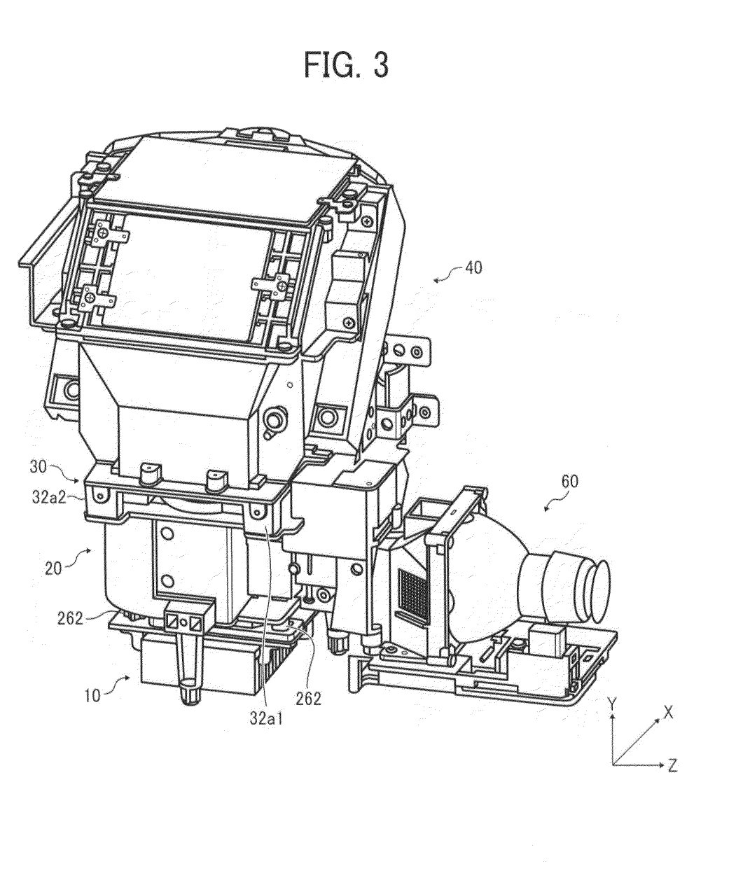

FIG. 3 shows a schematic perspective view of an internal configuration of the projector 1. As shown in FIG. 3, the image generation unit 10, the lighting unit 20, the first optical unit 30, the second optical unit 40 are arranged along the Y direction in FIG. 3. Further, a light source unit 60 can be disposed at a right side of the lighting unit 20 in FIG. 3.

Further, as shown in FIG. 3, the first optical unit 30 has a lens holder 32 having legs 32a1 and 32a2, and the image generation unit 10 has a screw stopper 262 used to fix the image generation unit 10 to the lighting unit 20 using a screw.

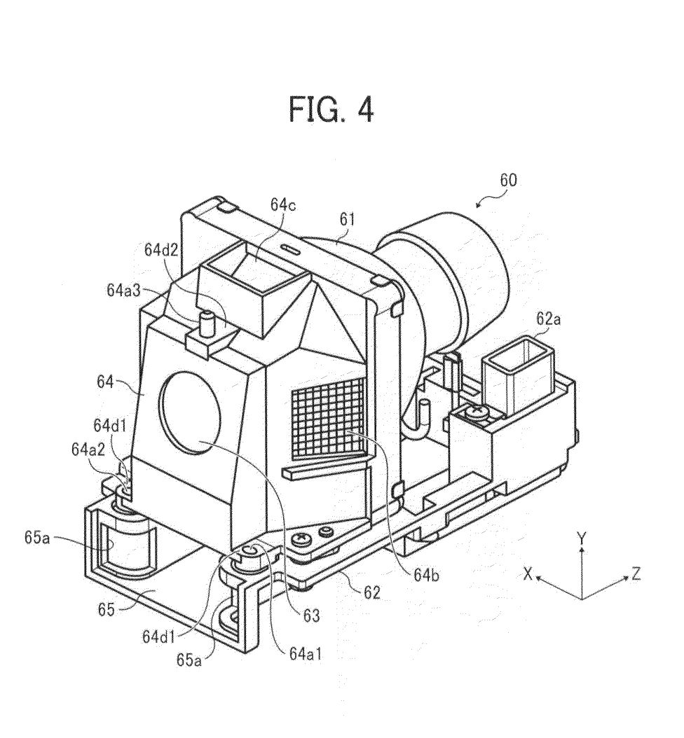

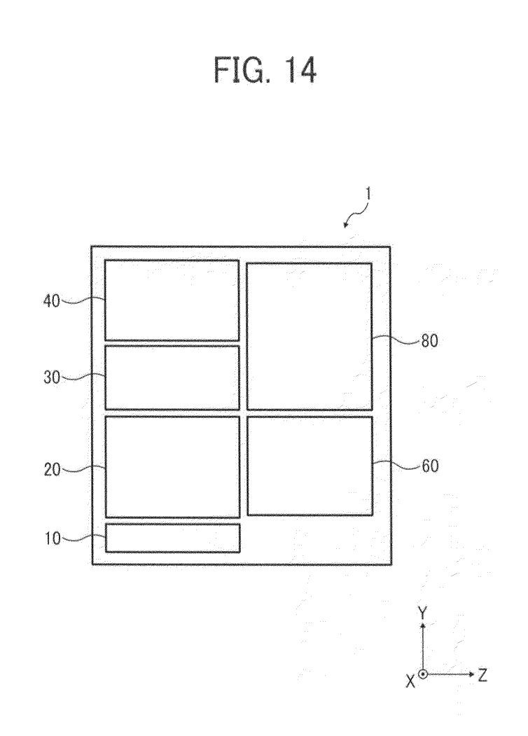

A description is given of configuration of each unit. Initially, the light source unit 60 is described. FIG. 4 shows a schematic perspective view of the light source unit 60. The light source unit 60 includes a light-source bracket 62, and a light source 61 fixed on the light-source bracket 62. The light source 61 is, for example, a halogen lamp, a metal-halide lamp, and a high-pressure mercury vapor lamp. Further, the light-source bracket 62 has a connector 62a connectable to a power-source connector of a power source unit 80 (FIG. 14).

Further, a holder 64 is fixed on the light exiting side of the light source 61 disposed on the light-source bracket 62 using screws, wherein the holder 64 retains a reflector or the like. Further, a light exiting window 63 is disposed for the holder 64 while the light exiting window 63 is disposed at a side opposite the position of the light source 61. The light emitted from the light source 61 can be guided to the light exiting window 63 by the reflector retained in the holder 64, and exits from the light exiting window 63.

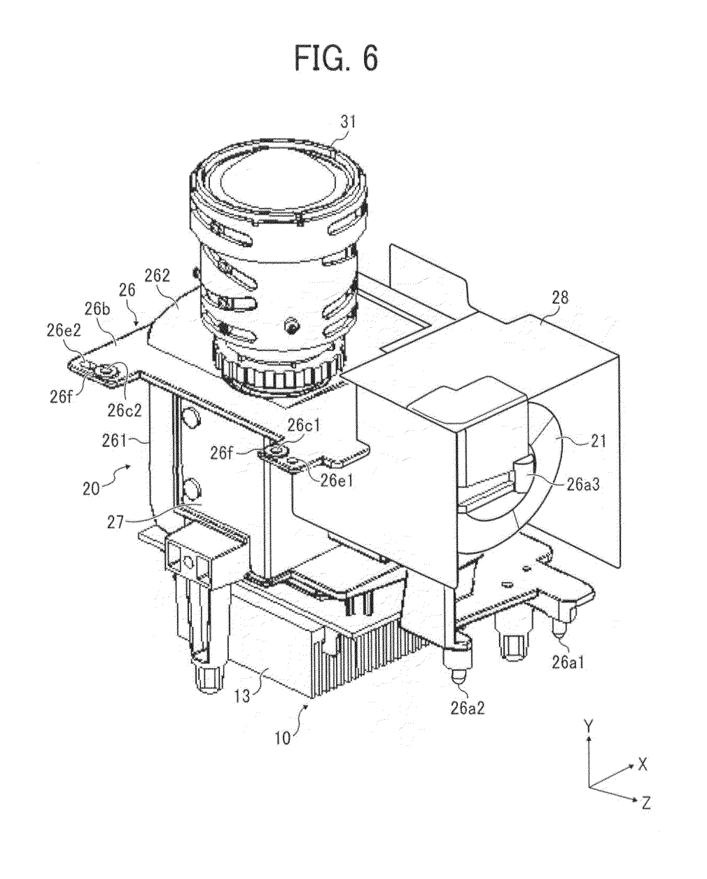

Further, light source position-setting members 64a1 to 64a3 are disposed at the top face of the holder 64 and both ends of the X direction of the bottom face of the holder 64 so that the light source unit 60 can be positioned correctly on a lighting unit bracket 26 of the lighting unit 20 (FIG. 6). For example, the light source position-setting member 64a3 disposed at the top face of the holder 64 has a protruded-shape, and the light source position-setting members 64a1 and 64a2 disposed at the bottom face of the holder 64 have a hole shape.

Further, a light-source air intake port 64b is disposed at a side face of the holder 64 to take in air used for cooling the light source 61, and a light-source air exhaust port 64c is disposed at the top face of the holder 64 to exhaust air heated by the heat of the light source 61.

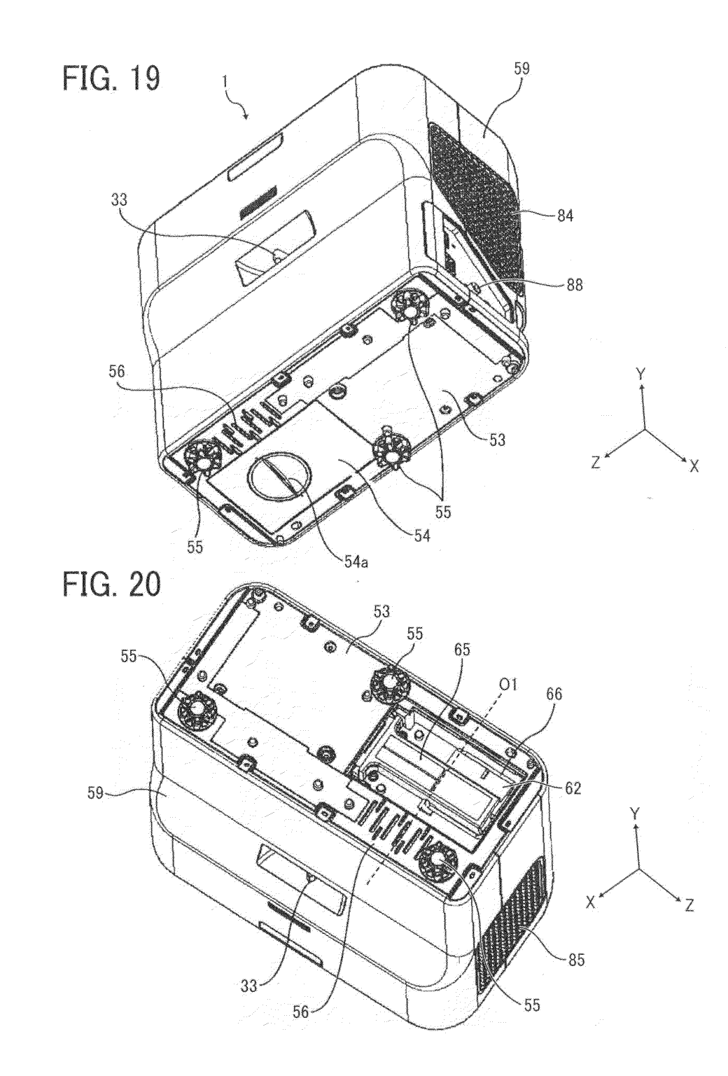

Further, a pass-through area 65 is disposed for the light-source bracket 62 to take in air sucked in by an air-intake blower 91 (FIG. 20) to be described later. Further, an opening 65a is disposed at an air-intake side of the pass-through area 65 as shown in FIG. 4 to send a part of airflow flowing into the pass-through area 65 to a space between the light source unit 60 and an openably closable cover 54 (FIG. 19), to be described later.

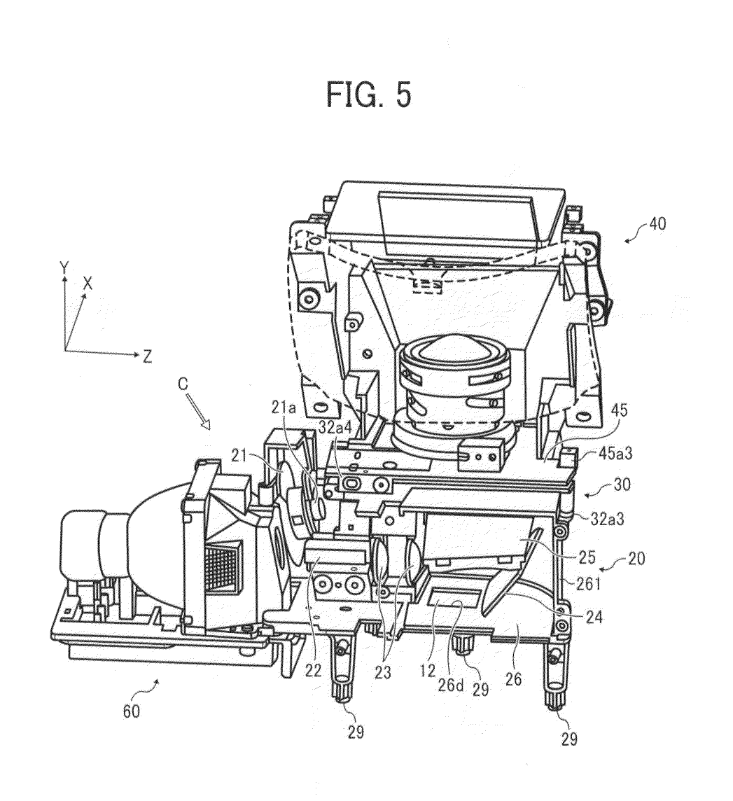

A description is given of the lighting unit 20 with reference to FIG. 5, which shows a perspective view of optical parts encased in the lighting unit 20 and other units. As shown in FIG. 5, the lighting unit 20 includes, for example, a color wheel 21, a light tunnel 22, two relay lenses 23, a cylinder mirror 24, and a concave mirror 25, wherein the parts can be retained by the lighting unit bracket 26. The lighting unit bracket 26 includes, for example, a casing 261 that encases the relay lenses 23, the cylinder mirror 24, and the concave mirror 25. Among four sides of the casing 261, only one side has a side face (i.e., right side of FIG. 5), and other three sides are opening. Further, an OFF plate 27 (FIG. 6) is disposed at one opening-side of the X direction in FIG. 5, and a cover member is disposed at another opening-side of the X direction in FIG. 5. With this configuration, the relay lenses 23, the cylinder mirror 24, and the concave mirror 25 encased in the casing 261 of the lighting unit bracket 26 can be covered by the lighting unit bracket 26, the OFF plate 27, and the cover member.

Further, a through-hole 26d is disposed on the bottom face of the casing 261 of the lighting unit bracket 26 so that the DMD 12 can be exposed through the through-hole 26d.

Further, the lighting unit bracket 26 includes, for example, three legs 29. The legs 29 can contact a base member 53 (FIG. 19) of the projector 1 to support the weight of the first optical unit 30 and the second optical unit 40 stacked and fixed on the lighting unit bracket 26. Further, by providing the legs 29, a space for taking in external air to a heat exchanger such as a heat sink 13 (FIG. 6) that cools the DMD 12 of the image generation unit 10, can be arranged, to be described later.

Further, as shown in FIG. 5, the lens holder 32 of the first optical unit 30 includes, for example, legs 32a3 and 32a4, and the second optical unit 40 includes, for example, a screw stopper 45a3.

FIG. 6 shows a perspective view of the image generation unit 10, the lighting unit 20, and a projection lens unit 31 viewed from the direction C shown in FIG. 5. The casing 261 of the lighting unit bracket 26 has a top face 26b extending in a direction perpendicular to the Y direction of FIG. 6. Through-holes are disposed at four corners of the top face 26b to fasten the first optical unit 30 with screws by inserting the screws into the through-holes. For example, FIG. 6 shows the through-holes 26c1 and 26c2.

Further, as shown in FIG. 6, position-setting holes 26e1 and 26e2 are respectively disposed next to the through-holes 26c1 and 26c2 to set the first optical unit 30 at a correct position with the lighting unit 20. As for the position-setting holes 26e1 and 26e2, the position-setting hole 26e1 disposed at the color wheel 21 side is used as a primary position-setting hole having a circular hole shape, and the position-setting hole 26e2 disposed at an opposite side of the color wheel 21 is used as a secondary position-setting hole having a slot hole extending in the Z direction.

Further, a position-setting protrusion 26f is disposed around each of the through-holes 26c1 and 26c2, wherein the position-setting protrusion 26f protrudes from the top face 26b of the lighting unit bracket 26. The position-setting protrusion 26f is used to set the first optical unit 30 at a correct position in the Y direction.

If the precision of positioning is to be enhanced in the Y direction without providing the position-setting protrusion 26f, the flatness of the entire top face of the lighting unit bracket 26 is required to be enhanced, which is costly. By providing the position-setting protrusion 26f, the flatness is required to be enhanced only at the position-setting protrusion 26f. Therefore, the precision of positioning can be enhanced in the Y direction while reducing the cost.

Further, the top face of the lighting unit bracket 26 has an opening covered by a light shield plate 263 engaging with the lower end of the projection lens unit 31, by which the intrusion of light from the upper side into the casing 261 can be prevented.

Further, the top face 26b of the lighting unit bracket 26 has a cutout between the through-holes 26c1 and 26c2 of the top face 26b so that the second optical unit 40 can be screwed to the first optical unit 30 easily, to be described later.

A light source positioning member 26a3 is disposed at one end of the lighting unit bracket 26 at the color wheel 21 side (Z direction in FIG. 6). The light source positioning member 26a3 has a cylinder-like shape having a through-hole, to which the light source position-setting member 64a3 having the protruded-shape (FIG. 4), disposed at the top face of the holder 64 of the light source unit 60, engages. Further, two light source positioning members 26a1 and 26a2 having protruded-shape are disposed at a lower side of the light source positioning member 26a3, to which the light source position-setting member 64a1 and 64a2 disposed on the holder 64 at the light-source bracket 62 side, which are through-holes, engage respectively. By respectively engaging the light source position-setting members 64a1 to 64a3 disposed for the holder 64 to the light source positioning members 26a1 to 26a3 disposed for the lighting unit bracket 26 of the lighting unit 20, the light source unit 60 can be fixed at the correct position of the lighting unit 20 (FIG. 3).

Further, the lighting unit bracket 26 includes a lighting unit cover 28 that covers the color wheel 21 and the light tunnel 22.

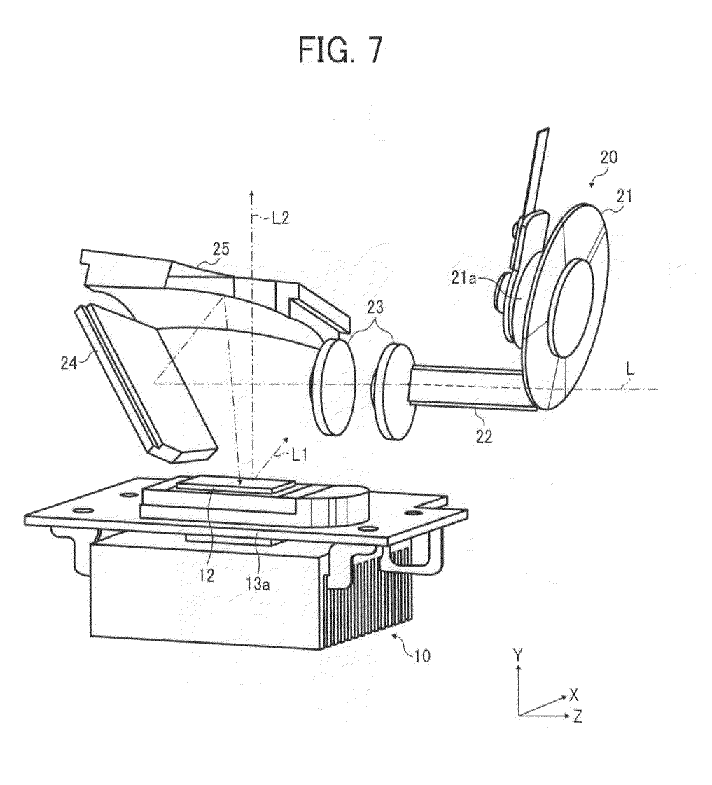

FIG. 7 shows a light path L of light in the lighting unit 20. The color wheel 21 has a disc shape and is fixed on a motor shaft of a color motor 21a. The color wheel 21 includes, for example, R (red), G (green), and B (blue) filters along the rotation direction of the color wheel 21. The light focused by a reflector disposed for the holder 64 of the light source unit 60 passes through the light exiting window 63, and then reaches the peripheral area of the color wheel 21. The light that has reached the peripheral area of the color wheel 21 is separated into R, G and B light along the timeline as the color wheel 21 rotates.

The light separated by the color wheel 21 enters the light tunnel 22. The light tunnel 22 is a tube-shaped member having a square-like cross shape, and its internal face is finished as a mirror face. The light entered the light tunnel 22 reflects a plurality of times on the internal face of the light tunnel 22, and is then emitted as uniform light to the relay lenses 23.

The light that has passed the light tunnel 22 passes the two relay lenses 23, reflects on the cylinder mirror 24 and the concave mirror 25, and is then focused on an image generation face of the DMD 12 as an image.

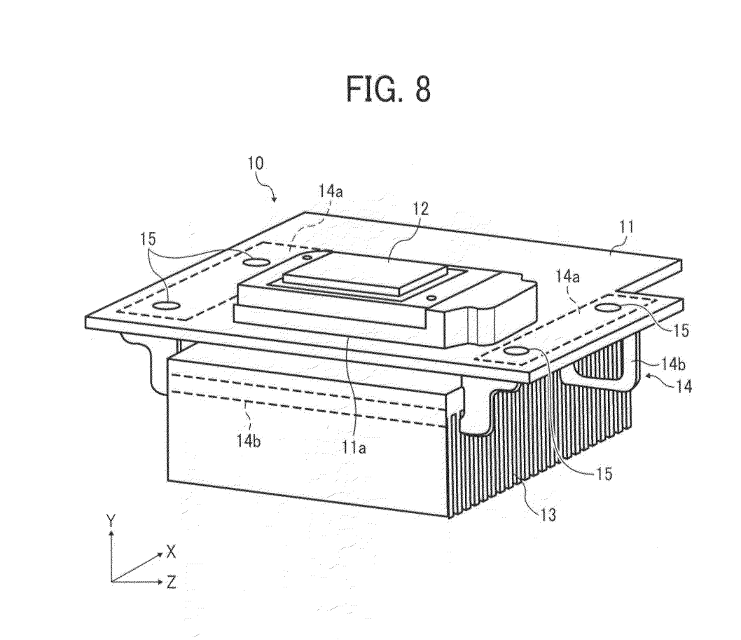

A description is given of the image generation unit 10 with reference to FIG. 8, which shows a perspective view of the image generation unit 10. As shown in FIG. 8, the image generation unit 10 includes, for example, a DMD board 11 to which the DMD 12 is attached. The DMD 12 is attached to a socket 11a disposed on the DMD board 11 while orienting an image generation face of the DMD 12 composed of micro mirrors arranged in a lattice pattern to an upward direction. The DMD board 11 includes a drive circuit to drive the micro mirrors.

A heat exchanger such as the heat sink 13 is fixed on a distal side of the DMD board 11 (i.e., a face opposite a face having the socket 11a) to cool the DMD 12. The DMD board 11 has a through-hole area to which the DMD 12 is attached, and the heat sink 13 has a protruded portion 13a (FIG. 7) insertable into the through-hole area. The protruded portion 13a has an edge portion having a flat shape. By inserting the protruded portion 13a into the through-hole area, the flat edge portion of the protruded portion 13a can contact the distal side of the DMD 12 (i.e., face opposite the image generation face). An elastic and flexible heat conduction sheet can be attached on the flat edge portion of the protruded portion 13a and/or an area of the distal side of the DMD 12 so that the heat sink 13 and the distal side of the DMD 12 can be closely contacted to enhance the thermal conductivity.

The heat sink 13 can be fixed on a face opposite a face disposed of the socket 11a of the DMD board 11 by applying pressure using a fixing device 14. The fixing device 14 includes, for example, a plate-like fixing part 14a at a right distal side of the DMD board 11 (right side in FIG. 8), and a plate-like fixing part 14a at a left distal side of the DMD board 11 (left side in FIG. 8) disposed at as counterpart members with each other. As shown in FIG. 8, one end and other end of the plate-like fixing parts 14a are linked by a pressure member 14b extending in the Z direction in FIG. 8.

When the image generation unit 10 is fixed on the lighting unit bracket 26 (FIG. 6) using screws, the heat sink 13 is pressed against and fixed to the face opposite the face disposed of the socket 11a of the DMD board 11 by applying force from the fixing device 14.

A description is given of fixing of the lighting unit bracket 26 of the image generation unit 10. Initially, the image generation unit 10 is positioned with respect to the lighting unit bracket 26 so that the DMD 12 can face the through-hole 26d disposed on the bottom face of the lighting unit bracket 26 of the lighting unit 20 (FIG. 5). Then, a screw is inserted into each of through-holes disposed for the fixing part 14a, and each of through-holes 15 disposed for the DMD board 11 from a lower side, and the screw is screwed into each of screw holes disposed at the bottom face of the screw stopper 262 (FIG. 3) of the lighting unit bracket 26 to fix the image generation unit 10 to the lighting unit bracket 26. Further, as the screw is screwed into the screw stopper 262 disposed for the lighting unit bracket 26, the pressure member 14b presses the heat sink 13 toward the DMD board 11. With this configuration, the heat sink 13 can be pressed and fixed on the face opposite the face disposed with the socket 11a of the DMD board 11 using the fixing device 14.

As above described, the image generation unit 10 can be fixed to the lighting unit bracket 26, and the three legs 29 shown in FIG. 5 can support the weight of the image generation unit 10.

The image generation face of the DMD 12 is composed of a plurality of movable micro mirrors arranged in a lattice pattern. Each of micro mirrors can incline the mirror face about a torsion shaft for a given angle, and can be set with two conditions of ON and OFF. When the micro mirror is set “ON,” the light coming from the light source 61 is reflected toward the first optical system 70 (FIG. 2) as shown by an arrow L2 shown in FIG. 7. When the micro mirror is set “OFF,” the light coming from the light source 61 is reflected toward the OFF plate 27, retained on the side face of the lighting unit bracket 26 shown in FIG. 6, as shown by an arrow L1 shown in FIG. 7. Therefore, by driving each mirror independently, the light projection can be controlled for each pixel of image data to generate an image.

The light reflected to the OFF plate 27 is absorbed as heat and then the OFF plate 27 is cooled by the airflow flowing outside of the OFF plate 27.

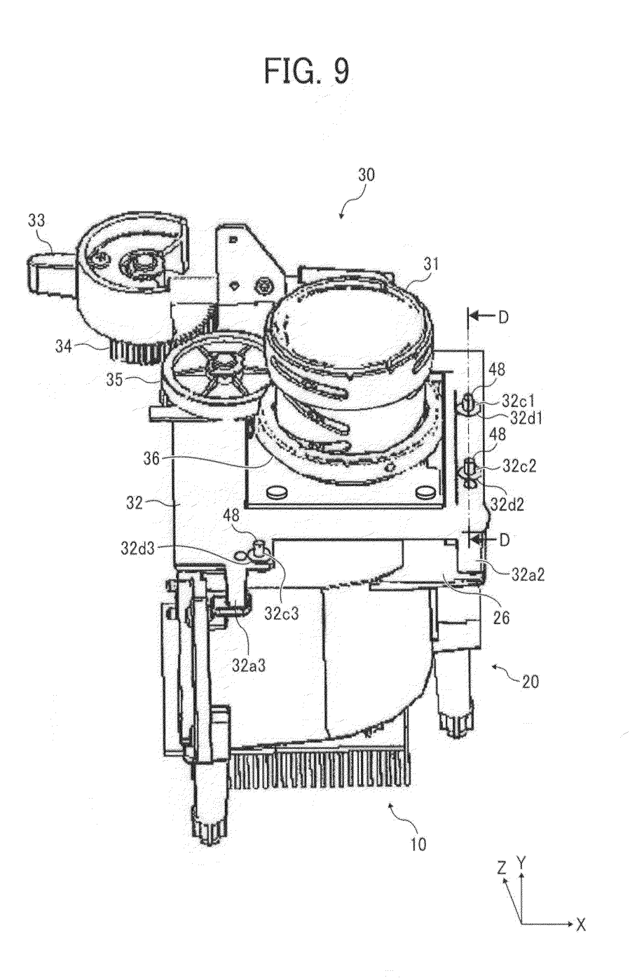

A description is given of the first optical unit 30 with reference to FIG. 9, which shows a perspective view of the first optical unit 30 with the lighting unit 20 and the image generation unit 10. As shown in FIG. 9, the first optical unit 30 is disposed over the lighting unit 20, and includes, for example, the projection lens unit 31, and the lens holder 32. The projection lens unit 31 retains the first optical system 70 (FIG. 2) composed of a plurality of lenses, and the lens holder 32 retains the projection lens unit 31. The lens holder 32 is disposed with four legs 32a1 to 32a4 extending toward the downside, wherein FIG. 9 shows the legs 32a2 and 32a3. The leg 32a1 is shown in FIG. 3, and the leg 32a4 is shown in FIG. 5. Each of the legs 32a1 to 32a4 is formed of a screw hole on its bottom face to be used when fixed with the lighting unit bracket 26 using a screw.

Further, the projection lens unit 31 is disposed with a focus gear 36 meshed with an idler gear 35. The idler gear 35 is meshed with a lever gear 34, and the focus lever 33 is fixed to a rotation shaft of the lever gear 34. As shown in FIG. 1, the end of the focus lever 33 is exposed outside of the projector 1.

When the focus lever 33 is operated, the focus gear 36 is rotated via the lever gear 34 and the idler gear 35. When the focus gear 36 is rotated, each of the plurality of lenses composing the first optical system 70 disposed in the projection lens unit 31 can be moved to a given direction to adjust a focal point of a projected image.

Further, the lens holder 32 includes, for example, threaded through-holes 32c1 to 32c3 so that the second optical unit 40 can be fixed with the first optical unit 30 using screws, in which a screw 48 is screwed into each of the threaded through-holes 32c1 to 32c3. FIG. 9 shows three threaded through-holes 32c1 to 32c3, and the screw 48 is inserted into each of the threaded through-holes 32c1 to 32c3. In FIG. 9, the end of the screw 48 is shown. Further, positioning protruded members 32d1 to 32d3 are respectively formed around each of the threaded through-holes 32c1 to 32c3, in which each of the positioning protruded members 32d1 to 32d3 protrudes from the face of the lens holder 32. FIG. 9 shows the positioning protruded members 32d1 to 32d3.

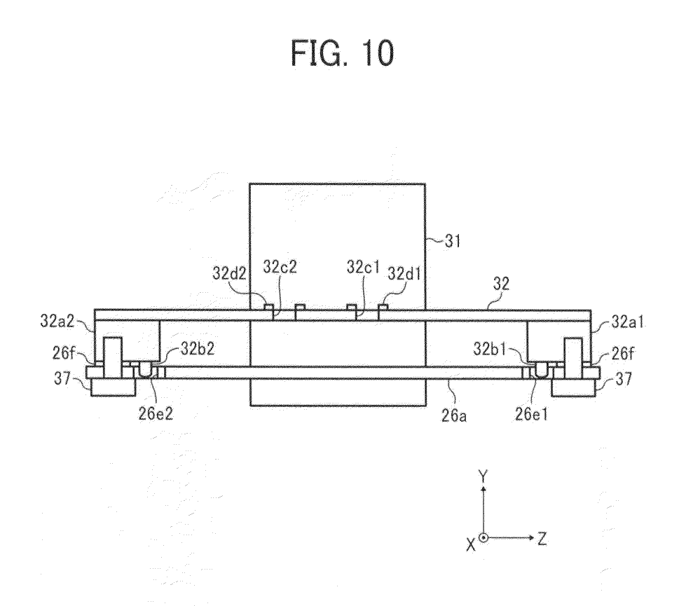

FIG. 10 shows a cross-sectional view along a line D-D of FIG. 9. As shown in FIG. 10, each of the legs 32a1 and 32a2 is disposed with positioning protruded members 32b1 and 32b2, respectively. The positioning protruded member 32b1 (right side in FIG. 10) is inserted in the position-setting hole 26e1 having the circular hole shape, which is the primary position-setting hole disposed on the top face 26b of the lighting unit bracket 26. The positioning protruded member 32b2 (left side in FIG. 10) is inserted in the position-setting hole 26e2 having the slot hole shape, which is the secondary position-setting hole. With this configuration, the position in the Z direction and X direction can be set correctly. Further, a screw 37 is inserted into each of the through-holes 26c1 to 26c4 disposed for the top face 26b of the lighting unit bracket 26, and then screwed into screw holes of each of the legs 32a1 to 32a4 of the lens holder 32, by which the first optical unit 30 can be fixed to the lighting unit 20 with a correct position.

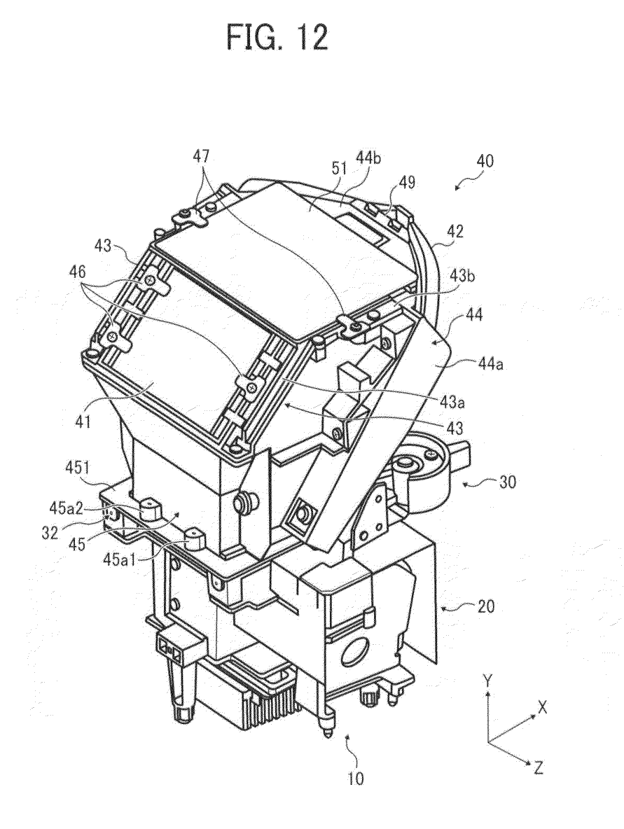

The second optical unit 40 includes a mirror holder 45 (FIG. 12) that covers a portion of the projection lens unit 31 above the lens holder 32 to be described later. Further, as shown in FIG. 3, a space between a part of the lens holder 32, lower than a part of the lens holder 32 corresponding to the projection lens unit 31 and the top face 26b of the lighting unit bracket 26 of the lighting unit 20 is exposed outside. However, because the projection lens unit 31 engages the lens holder 32, the light does not enter the light path of projection light from the exposed part.

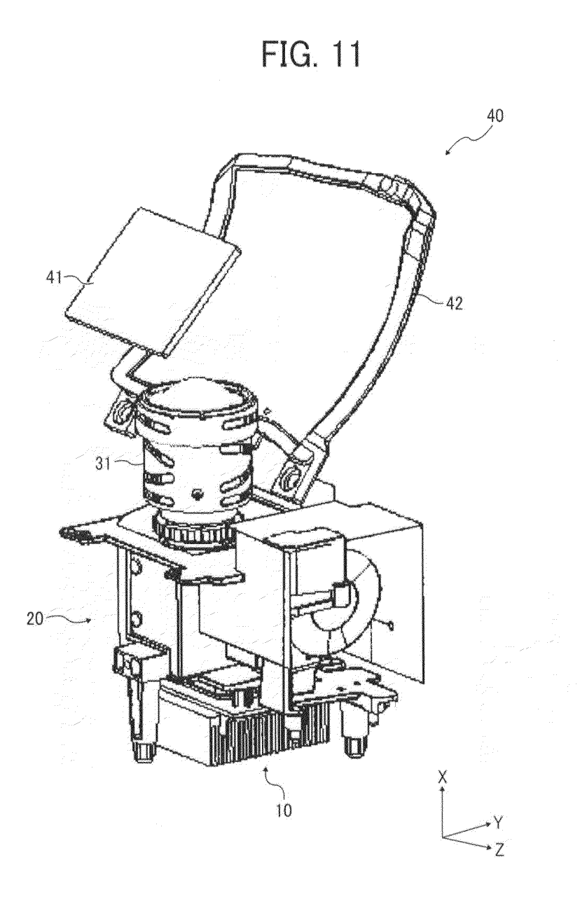

A description is given of the second optical unit 40 with reference to FIGS. 11 and 12. FIG. 11 shows a perspective view of the second optical unit 40 used as a second optical system configured with the projection lens unit 31, the lighting unit 20, and the image generation unit 10. As shown in FIG. 11, the second optical unit 40 includes, for example, the reflection mirror 41, and the curved mirror 42 having the concave shape. The reflection face of the curved mirror 42 can be finished as a circular face, a rotation symmetrical non-circular face, a free curve shape, or the like.

FIG. 12 shows a perspective view of the second optical unit 40 with the first optical unit 30, the lighting unit 20, and the image generation unit 10. The second optical unit 40 passes the light reflected from the curved mirror 42, and includes the transparent glass 51 to prevent intrusion of dust to optical parts in the projector 1, wherein the transparent glass 51 is used as an exit window.

The second optical unit 40 includes, for example, a mirror bracket 43, a free mirror bracket 44, and a mirror holder 45. The mirror bracket 43 retains the reflection mirror 41 and the transparent glass 51. The free mirror bracket 44 retains the curved mirror 42. The mirror holder 45 holds the mirror bracket 43 and the free mirror bracket 44.

The mirror holder 45 has a box-like shape while the upper side, lower side, and one side such as right side in the X direction in FIG. 12 are opened, and thereby the mirror holder 45 has a U-like shape when viewed from the top. The upper part of the mirror holder 45 includes an inclined portion extending along a direction set between the middle of the X and Y directions by increasing the height, and includes a parallel face parallel to the X direction. The inclined portion is disposed at a proximal side of the parallel face in the X direction. Further, the peripheral side of upper opening of the mirror holder 45 disposed at a proximal side in the X direction and extending in the Z direction is parallel to the Z direction in FIG. 12.

The mirror bracket 43 is attached to the upper part of the mirror holder 45. The mirror bracket 43 includes an inclined side 43a and a horizontal side 43b. The inclined side 43a rises along a direction set between the middle of the X and Y directions by increasing the height as shown in FIG. 12. The horizontal side 43b extends in a direction parallel to the X direction in FIG. 12. The inclined side 43a contacts the peripherals of the inclined portion of the mirror holder 45, and the horizontal side 43b contacts the peripherals of the horizontal part of the mirror holder 45, which is the top of the mirror holder 45. The inclined side 43a includes an opening, and the reflection mirror 41 is retained to cover the opening of the inclined side 43a. The horizontal side 43b includes an opening, and the transparent glass 51 is retained to cover the opening of the horizontal side 43b.

Each end of the reflection mirror 41 in the Z direction is pressed to the inclined side 43a of the mirror bracket 43 by the mirror pressing member 46 such as a leaf spring to hold the reflection mirror 41 at the inclined side 43a of the mirror bracket 43. For example, as shown in FIG. 12, one end of the reflection mirror 41 in the Z direction is fixed by the two mirror pressing members 46, and other end of the reflection mirror 41 in the Z direction is fixed by the one mirror pressing member 46.

Each end of the transparent glass 51 in the Z direction is pressed to the horizontal side 43b of the mirror bracket 43 by a glass pressing member 47 such as a leaf spring to hold the transparent glass 51 on the mirror bracket 43. Each end of the transparent glass 51 in the Z direction is retained using one glass pressing member 47 at each end in the Z direction.

The free mirror bracket 44 to retain the curved mirror 42 includes an arm portion 44a at each side of the free mirror bracket 44, in which the arm portion 44a extends and inclines along a direction set between the middle of the X and Y directions as shown in FIG. 12. Further, the free mirror bracket 44 includes a link portion 44b that links the two arm portions 44a at the upper portion of the arm portions 44a. The arm portion 44a of the free mirror bracket 44 is attached to the mirror holder 45 so that the curved mirror 42 covers an opening of the mirror holder 45.

The curved mirror 42 pressed toward the link portion 44b of the free mirror bracket 44 by a free mirror pressing member 49 such as a leaf spring at a substantially center of one end side of the transparent glass 51. Further, each end side of the first optical system 70 in the Z direction in FIG. 12 is fixed to the arm portion 44a of the free mirror bracket 44 using a screw.

The second optical unit 40 is stacked and fixed on the lens holder 32 of the first optical unit 30. Specifically, the bottom side of the mirror holder 45 has a bottom face 451 that faces an upper face of the lens holder 32. The bottom face 451 has three screw stoppers 45a1 to 45a3 having tube-like shape, which can be fixed with the first optical unit 30 by screws. FIG. 12 shows the screw stoppers 45a1 and 45a2, and FIG. 5 shows the screw stopper 45a3. The second optical unit 40 is fixed to the first optical unit 30 using screws, in which the screw 48 is inserted into each of the threaded through-holes 32c1 to 32c3 provided for the lens holder 32 of the first optical unit 30, and screwed into each of the screw stoppers 45a1 to 45a3 to fix the second optical unit 40 to the first optical unit 30.

In this configuration, the bottom face of the mirror holder 45 of the second optical unit 40 contacts the positioning protruded members 32d1 to 32d3 of the lens holder 32, by which the second optical unit 40 can be fixed at a correct position in Y direction.

As shown in FIG. 12, when the second optical unit 40 is stacked and fixed on the lens holder 32 of the first optical unit 30, a portion of the projection lens unit 31 that is above the lens holder 32 is encased in the mirror holder 45 of the second optical unit 40. Further, when the second optical unit 40 is stacked and fixed on the lens holder 32, a space is set between the curved mirror 42 and the lens holder 32, and the idler gear 35 (FIG. 9) may be set in the space.

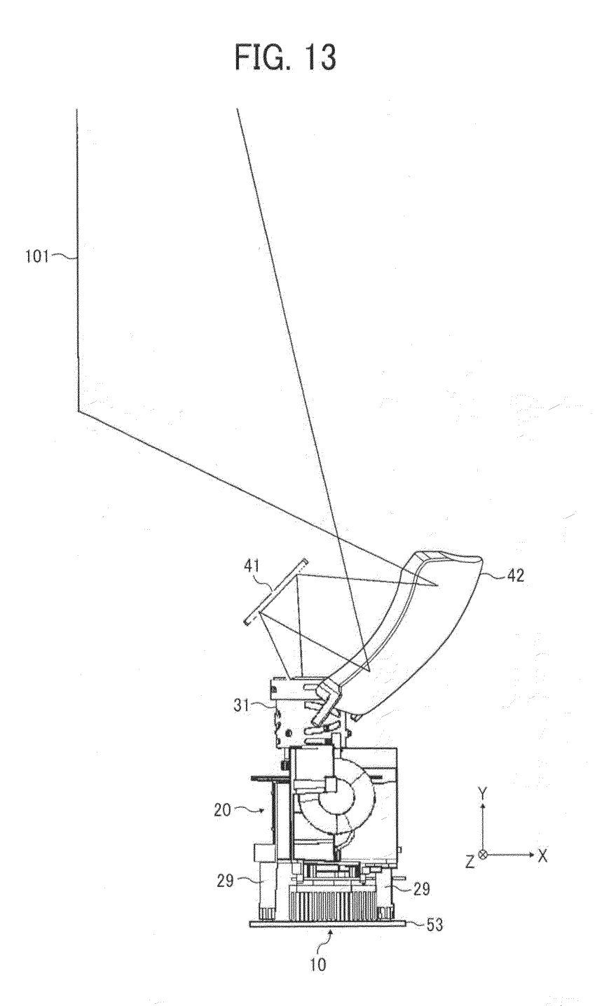

FIG. 13 shows a schematic view of the light path from the first optical system 70 to the projection plane 101 such as a screen. The light flux that has passed through the projection lens unit 31 configuring the first optical system 70 is used to generate an intermediate image between the reflection mirror 41 and the curved mirror 42, which is a conjugate image with respect to an image generated by the DMD 12. The intermediate image is generated as a curved image between the reflection mirror 41 and the curved mirror 42. The intermediate image enters the curved mirror 42 having a concave shape, and the curved mirror 42 enlarges the intermediate image and projects the enlarged image onto the projection plane 101.

As above described, an optical projection system can be configured with the first optical system 70, and the second optical system. In this configuration, the intermediate image is generated between the first optical system 70 and the curved mirror 42 of the second optical system, and the intermediate image is enlarged and projected by the curved mirror 42, by which the projection distance to the screen can be set shorter. Therefore, the projector 1 can be used in small meeting rooms or the like.

Further, as shown in FIG. 13, the first optical unit 30 and the second optical unit 40 are stacked and fixed to the lighting unit bracket 26. Further, the image generation unit 10 is fixed to the lighting unit bracket 26. Therefore, the legs 29 of the lighting unit bracket 26 can be fixed to the base member 53 while supporting the weight of the first optical unit 30, the second optical unit 40, and the image generation unit 10.

FIG. 14 schematically shows a layout of units in the projector 1. As shown in FIG. 14, the image generation unit 10, the lighting unit 20, the first optical unit 30, and the second optical unit 40 are stacked along the Y direction, which is the short side direction of the projection plane 101. As shown in FIG. 14, the light source unit 60 is arranged in the Z direction with respect to other stacked units composed of the image generation unit 10, the lighting unit 20, the first optical unit 30, and the second optical unit 40, which is the long side direction of the projection plane 101. In an example embodiment, the image generation unit 10, the lighting unit 20, the first optical unit 30, the second optical unit 40, and the light source unit 60 can be arranged along the Y direction and Z directions, which are parallel to a projected image and the projection plane 101.

Specifically, a projection optical system B having the first optical unit 30 and the second optical unit 40 is stacked on the image generator A having the image generation unit 10 and the lighting unit 20. The light source unit 60 is coupled to the image generator A in a direction perpendicular to the stacking direction of the image generator A and the projection optical system B. Further, the image generator A and the light source unit 60 can be arranged along a direction parallel to the base member 53. Further, the image generator A and the projection optical system B may be arranged along a direction perpendicular to the base member 53, in which the image generator A is disposed over the base member 53, and then the projection optical system B is disposed over the image generator A. With this configuration, an installation space of the projector 1 in the direction perpendicular to the projection plane 101 use for projecting image can be suppressed. With this configuration, when an image projection apparatus is used in a small room by placing the image projection apparatus on a table, the installation of the image projection apparatus may not cause a problem of a layout of table and chairs.

Further, as shown in FIG. 14, a power source unit 80 is stacked or disposed above the light source unit 60, wherein the power source unit 80 supplies power to the light source 61 and the DMD board 11. The light source unit 60, the power source unit 80, the image generator A, and the projection optical system B are encased in a casing of the projector 1. The casing of the projector 1 includes the top face of the projector 1, the base member 53, and an outer cover 59 (FIG. 19) used as the side face of the projector 1 to be described later.

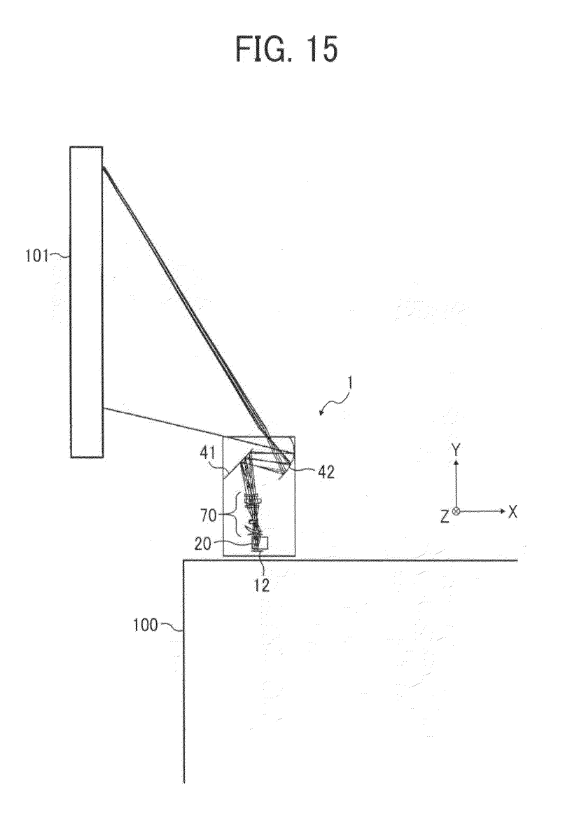

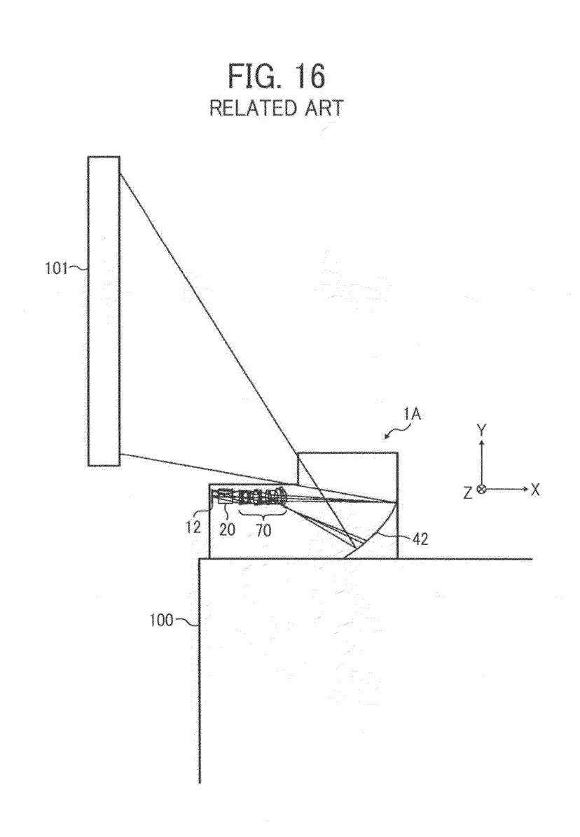

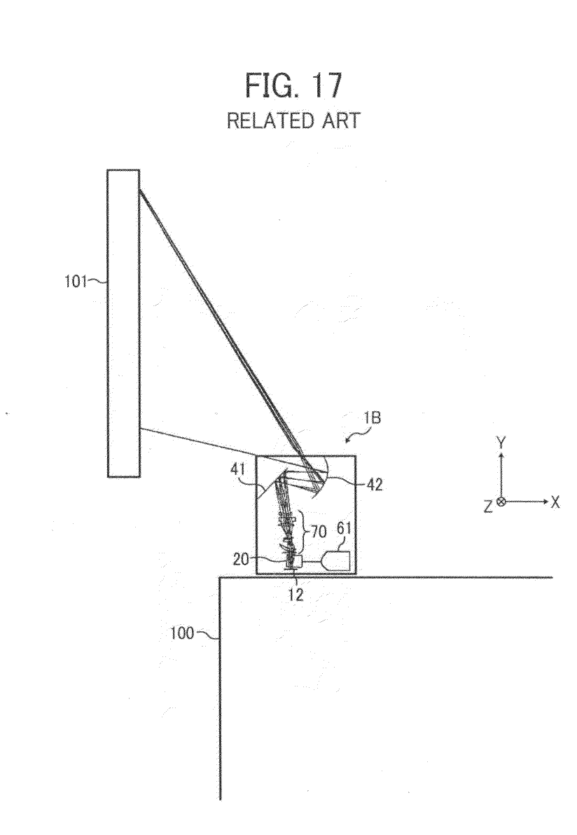

FIG. 15 shows an example of use environment of the projector 1 according to an example embodiment, and FIGS. 16 and 17 show examples of use environment of conventional projectors 1A and 1B. As shown in FIG. 15 to FIG. 17, when the projector is used in a meeting room, the projector may be placed on a table 100, and images are projected on the projection plane 101 such as a white board.

As shown in FIG. 16, as for the conventional projector 1A, the DMD 12, the lighting unit 20, the first optical system 70, and the second optical system such as the curved mirror 42 are serially arranged along in the direction perpendicular to the projection plane 101 to which a projected image is projected. Therefore, the length of the projector 1A in the direction perpendicular to the projection plane 101 (i.e., X direction) becomes longer, and thereby a greater space is required for the projector 1A in the direction perpendicular to the projection plane 101.

Typically, chairs that participants sit and desks that participants use may be arranged in the direction perpendicular to the projection plane 101 when to see images projected on the projection plane 101. Therefore, if a greater space for the projector 1A is required in the direction perpendicular to the projection plane 101, the arrangement space for chairs and the arrangement space for desks are restricted, and thereby not convenient when the projector is used.

As shown in FIG. 17, as for the conventional projector 1B, the DMD 12, the lighting unit 20, and the first optical system 70 are serially arranged along in a direction parallel to the projection plane 101 to which a projected image is projected. Therefore, compared to the projector 1A shown in FIG. 16, the length of the projector 1B in the direction perpendicular to the projection plane 101 can be set shorter. However, as for the projector 1B of FIG. 17, the light source 61 is arranged in the direction perpendicular to the projection plane 101 and is arranged after the lighting unit 20 in the direction perpendicular to the projection plane 101, and thereby the length of the projector 1B in the direction perpendicular to the projection plane 101 may not be effectively set shorter.

As for the projector 1 of an example embodiment shown in FIG. 15, the image generator A having the image generation unit 10 and the lighting unit 20, and the projection optical system B having the first optical unit 30 and the reflection mirror 41 are serially arranged along in a direction parallel to the projection plane 101, to which a projected image is projected. In this configuration, the image generator A and the projection optical system B are serially arranged along in a direction parallel to the Y direction in FIG. 15. Further, the light source unit 60 and the lighting unit 20 are serially arranged along in a direction parallel to the projection plane 101, which means the light source unit 60 and the lighting unit 20 are serially arranged along the Z direction in FIG. 15.

As above described, as for the projector 1 according to an example embodiment, the light source unit 60, the image generation unit 10, the lighting unit 20, the first optical unit 30, and the reflection mirror 41 can be arranged in a direction parallel to the projection plane 101 such as the Z direction or Y direction in FIG. 15. As above described, the light source unit 60, the image generation unit 10, the lighting unit 20, the first optical unit 30, and the reflection mirror 41 can be arranged in a direction parallel to the projection plane 101 such as the Z direction or Y direction in FIG. 15. Therefore, the length of the projector 1 in the direction perpendicular to the projection plane 101 (i.e., X direction in FIG. 15) can be set shorter than the length of the projectors 1A and 1B shown in FIG. 16 and FIG. 17. With this configuration, the projector 1 may not cause problems when arranging a space for chairs and desks, by which the projector 1 having a good enough level of convenience can be devised.

Further, as shown in FIG. 14, the power source unit 80 is stacked or disposed above the light source unit 60 to supply power to the light source 61 and the DMD board 11, by which the length of the projector 1 in the Z direction can be set shorter.

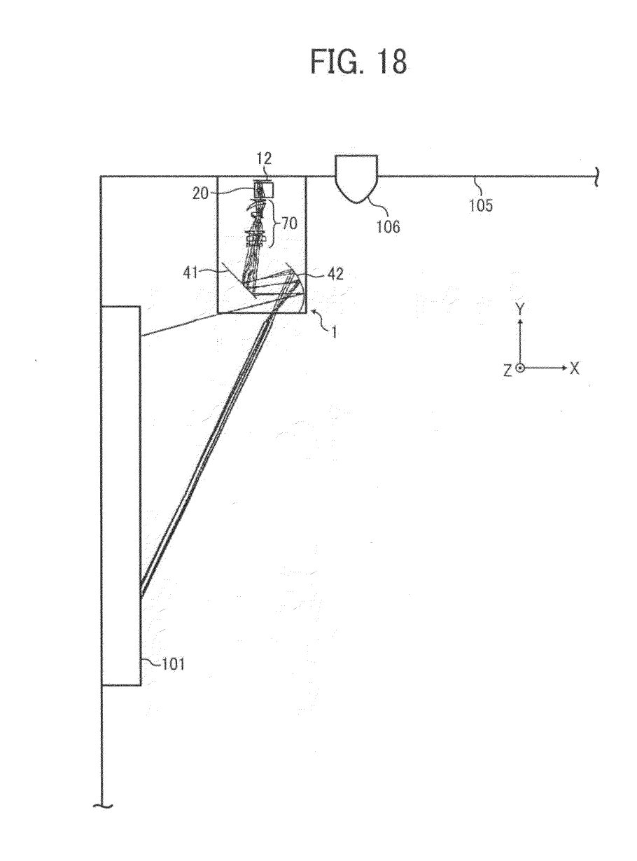

FIG. 18 shows another example use of the projector 1 according to an example embodiment. As shown in FIG. 18, the projector 1 can be fixed on a ceiling 105. Because the projector 1 has a short side in the direction perpendicular to the projection plane 101, the projector 1 can be fixed on the ceiling 105 without interference to a lighting device 106 disposed on the ceiling 105.

Further, although the second optical system may be configured with the reflection mirror 41 and the curved mirror 42, but the second optical system can be configured with only the curved mirror 42. Further, the reflection mirror 41 can be a plane mirror, a mirror having a positive refractive power, and a mirror having a negative refractive power. Further, the curved mirror 42 may be a concave mirror or a convex mirror. When the curved mirror 42 is a convex mirror, the first optical system 70 is configured in a way so that no intermediate image is generated between the first optical system 70 and the curved mirror 42.

Because the light source 61 has a lifetime for effective use, the light source 61 is required to be replaced with a new one periodically. Therefore, the light source unit 60 is detachably attached to a body of the projector 1.

FIG. 19 shows a perspective view of the projector 1 viewed from a bottom face of the projector 1, wherein the bottom face may be placed on a table. As shown in FIG. 19, the bottom face of the projector 1 includes the base member 53 and the openably closable cover 54. The openably closable cover 54 includes a rotate-able member 54a. When the rotate-able member 54a is rotated, the openably closable cover 54 is unlocked from the body of the projector 1, by which the openably closable cover 54 can be removed from the body of the projector 1. Further, the base member 53 includes, for example, a power-source air intake port 56 at a position next to the openably closable cover 54 in the X direction.

Further, as shown in FIG. 19, an air-intake port 84 and the input unit 88 are disposed on one Y-X plane of the outer cover 59 of the projector 1. The input unit 88 is used to input image data from external apparatuses such as personal computers.

FIG. 20 shows a perspective view of the projector 1 when the openably closable cover 54 is removed from the projector 1. When the openably closable cover 54 is removed, the light-source bracket 62 of the light source unit 60 is exposed, wherein the exposed side is the opposite side that the light source 61 is attached. The light-source bracket 62 includes a knob 66, which is pivotable about the pivot center O1 indicated by a dotted line in FIG. 20.

When removing the light source unit 60 from the body of the projector 1, the knob 66 is pivoted and opened by picking the knob 66, by which the light source unit 60 can be removed from an opening of the body of the projector 1. When attaching the light source unit 60 into the body of the projector 1, the light source unit 60 is inserted into the body of the projector 1 through the opening. When the light source unit 60 is inserted into the body of the projector 1, the connector 62a (FIG. 4) is connected with a power-source connector in the body of the projector 1, and the three light source position-setting members 64a1 to 64a3 of the holder 64 (FIG. 4) engage with three light source positioning members 26a1 to 26a3 (FIG. 6) disposed for the lighting unit bracket 26 of the lighting unit 20, by which the light source unit 60 is set at a correct position in the body of the projector 1, and the attachment of the light source unit 60 completes. Then, the openably closable cover 54 is attached to the base member 53.

As above described, the knob 66 is provided for the light source unit 60, but the pass-through area 65 shown in FIG. 20, which protrudes to the openably closable cover 54 can be used as a knob. The pass-through area 65 may be also referred to as the duct 65.

Further, the base member 53 is disposed with three legs 55. By rotating the legs 55, the protruded length of the legs 5 from the base member 53 can be changed, by which the height adjustment in the Y direction of the projector 1 can be conducted.

Further, as shown in FIG. 20, an exhaust port 85 is disposed at other Y-X plane of the outer cover 59.

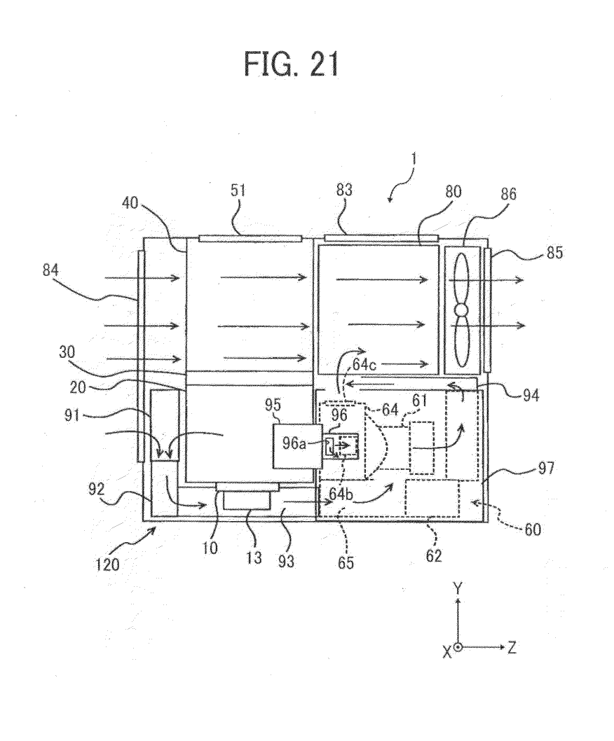

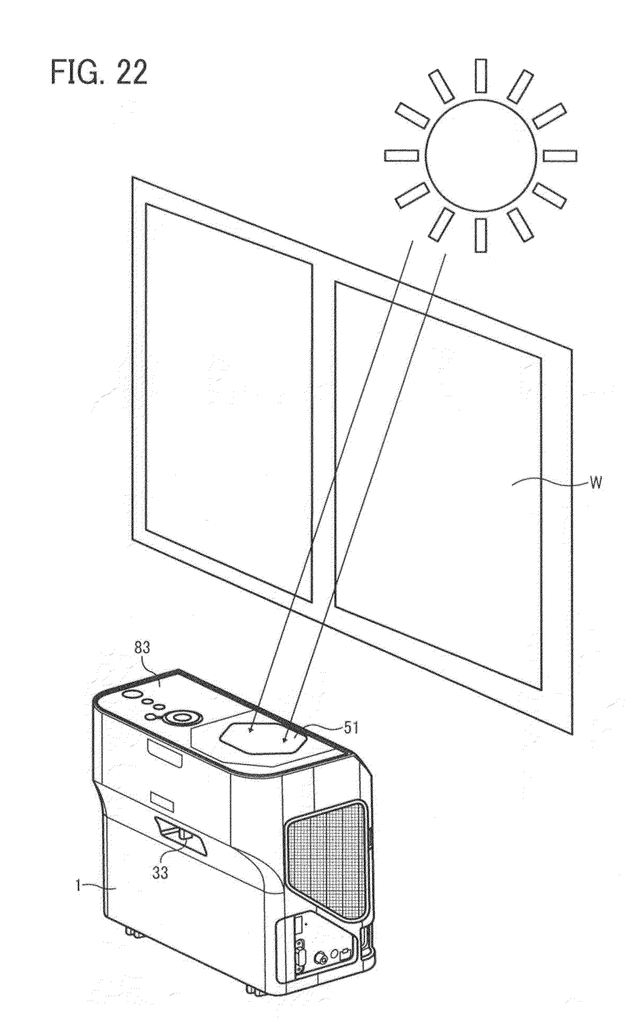

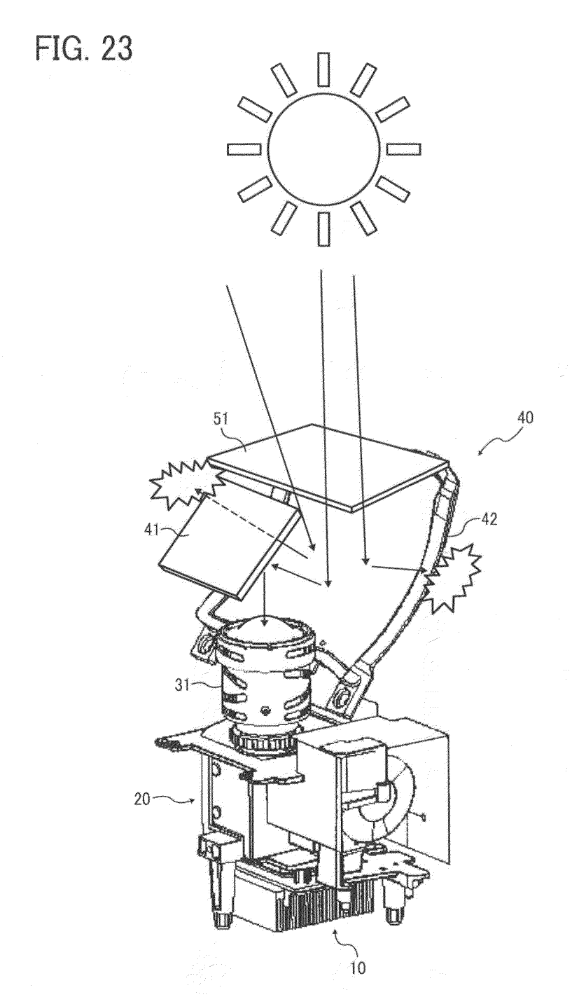

FIG. 21 shows a schematic view of airflow in the projector 1 according to an example embodiment. FIG. 21 shows the projector 1 viewed from the X direction, wherein the X direction is perpendicular to the projection plane 101. FIG. 22 shows a cross-sectional view of an internal configuration of the projector 1 corresponding to the view of FIG. 21. The arrows shown in FIG. 21 and FIG. 22 indicate directions of airflow. FIG. 23 shows a cross-sectional view of the projector 1 cut at line E-E in FIG. 22.

As shown in FIG. 21, the projector 1 includes the air-intake port 84 disposed its one face (left side in FIG. 21), and the exhaust port 85 disposed its other face (right side in FIG. 21). The air-intake port 84 has an opening to intake external air into the projector 1. The exhaust port 85 has an opening to exhaust air from the projector 1. Further, an exhaust fan 86 is disposed at a position facing the exhaust port 85.

When the projector 1 is viewed from the X direction, which is a direction perpendicular to the projection plane 101, a part of the exhaust port 85 and a part of the air-intake port 84 may be disposed between the light source unit 60 and the operation unit 83. Further, a flow path is set between a rear face of the curved mirror 42 and the outer cover 59 facing the rear face of the curved mirror 42 so that air can flow in such space. With this configuration, the external air taken from the air-intake port 84 can flow through along the Z-Y plane of the mirror holder 45 of the second optical unit 40 (FIG. 12), and the rear face of the curved mirror 42 by following the mirror holder 45 and curving of the rear face of the curved mirror 42, and then flow to the exhaust port 85.

Further, the power source unit 80 has a configuration having three sides. Therefore, when the power source unit 80 disposed over the light source unit 60 is viewed from the Z direction in FIG. 21, the power source unit 80 can be viewed as a U-shape configuration without a side facing the light source unit 60. Further, the external air taken from the air-intake port 84 flows along the mirror holder 45 and the curving of the rear face of the curved mirror 42 toward the exhaust port 85, and then further flows to a space encircled by the power source unit 80 having the three sides, and is then exhausted from the exhaust port 85.

As above described, the part of the exhaust port 85 and the air-intake port 84 are disposed between the light source unit 60 and the operation unit 83 when the projector 1 is viewed from the X direction, which is a direction perpendicular to the projection plane 101. In this configuration, an airflow passing through a space between the light source unit 60 and the operation unit 83 and exhausted from the exhaust port 85 can be generated.

Further, a light source blower 95 is disposed at a position that can suck air around the color motor 21a (FIG. 5) that drives the color wheel 21 in the lighting unit 20. With this configuration, the color motor 21a and the light tunnel 22 can be cooled using the airflow generated by the air sucking effect of the light source blower 95.

The air sucked in by the light source blower 95 passes a light source duct 96, and then flows into a light-source air supply port 64b (FIG. 4) of the holder 64. Further, a part of the air flowing into the light source duct 96 flows into a space between a light source housing 97 and the outer cover 59 from an opening 96a formed on a face of the light source duct 96 opposing the outer cover 59 (FIG. 19).

The air flowing into the space between the light source housing 97 and the outer cover 59 from the opening 96a of the light source duct 96 cools the light source housing 97 and the outer cover 59, and is then exhausted from the exhaust port 85 using the exhaust fan 86, which will be described later.

Further, the air flowing to the light-source air supply port 64b flows into the light source 61 to cool the light source 61, and is then exhausted from the light-source air exhaust port 64c disposed on the top face of the holder 64. The air exhausted from the light-source air exhaust port 64c is then exhausted from an opening formed on the top face of the light source housing 97 to a space encircled by the power source unit 80. Then, the air exhausted from the light source housing 97 (i.e., high-temperature air) is mixed with external air (i.e., low-temperature air) that flows around the second optical unit 40 and then flows into the space encircled by the power source unit 80, and then the mixed air is exhausted from the exhaust port 85 using the exhaust fan 86.

As above described, the high-temperature air exhausted from the light-source air exhaust port 64c is mixed with the external air (i.e., low-temperature air), and then exhausted from the exhaust port 85. Therefore, exhausting of the high-temperature air from the exhaust port 85 can be prevented, and the temperature of air exhausted from the exhaust port 85 can be decreased to a lower temperature.

Further, the operation unit 83 is preferably disposed on a top face of the projector 1 so that the user can operate the operation unit 83 easily. Because the projector 1 includes the transparent glass 51 on its top face for projecting images on the projection plane 101, the operation unit 83 may be disposed on a position corresponding to the light source 61 when viewing the projector 1 from the Y direction.

As above described, the low-temperature air, flowing through a space between the light source unit 60 and the operation unit 83 from the air-intake port 84 toward the exhaust port 85, can be used to cool the high-temperature air, which has become high temperature when the air has cooled the light source 61, by which the low-temperature air and high-temperature air become mixed air. Such mixed air is then exhausted from the exhaust port 85, and thereby the movement of high temperature air to the operation unit 83 can be prevented.

With this configuration, the temperature increase of the operation unit 83, which may be caused by the high temperature air coming from the light source 61, can be prevented. Further, a part of air, flowing from the air-intake port 84 to the exhaust port 85, flows around the second optical unit 40 and then under the operation unit 83 to cool the operation unit 83. Therefore, the temperature increase of the operation unit 83 can be prevented.

Further, when the exhaust fan 86 sucks in air, external air can be sucked from the power-source air intake port 56 disposed on the base member 53 (FIG. 19). A ballast board to supply power or current to the light source 61 is disposed at a position distal of the light source housing 97 in the X direction of FIG. 21. The external air sucked from the power-source air intake port 56 can flow through a space between the light source housing 97 and the ballast board in the upward direction to cool the ballast board. Then, the air flows to a space encircled by the power source unit 80 disposed over the ballast board, and is then exhausted from the exhaust port 85 using the exhaust fan 86.

In an example embodiment, a fan to generate the airflow from the air-intake port 84 to the exhaust port 85 is disposed at an exhaust side, in which the exhaust fan 86 is used as a fan. If the fan is provided at the exhaust side, the air supply volume from the air-intake port 84 into the projector 1 can be set greater than a fan disposed near the air-intake port 84.

If the fan is disposed near the air-intake port 84, the flow rate of external air supplied into the projector 1 may be decreased because the second optical unit 40 exists in a direction that the fan supplies air.

In contrast, if the fan (e.g., exhaust fan 86) is disposed near the exhaust port 85, the flow rate exhausted from the exhaust fan 86 may not decrease because objects may not exist outside the exhaust port 85. Therefore, when a given volume of air is exhausted from the exhaust fan 86, the same volume of air can be taken from the air-intake port 84, by which the air volume supplied from the air-intake port 84 into the projector 1 may not decrease. Therefore, the air can flow from the air-intake port 84 toward the exhaust port 85 at a given wind pressure, by which hot air rising from the light source 61 can effectively flow to the exhaust port 85 using the air flow flowing from the air-intake port 84 toward the exhaust port 85.

Further, a cooling unit 120 to cool the heat sink 13 of the image generation unit 10 and the light-source bracket 62 of the light source unit 60 is disposed at the lower left side of the projector 1 as shown in FIG. 21. The cooling unit 120 includes, for example, an air-intake blower 91, a vertical duct 92 disposed under the air-intake blower 91, and a horizontal duct 93 connected at the bottom of the vertical duct 92.

The air-intake blower 91 is disposed at a lower side of the air-intake port 84 while facing the air-intake port 84. The air-intake blower 91 sucks external air from the air-intake port 84 via a side face of the air-intake blower 91 facing the air-intake port 84, and also sucks air from the body of the projector 1 from another side, opposite the side face of the air-intake blower 91 facing the air-intake port 84. The sucked airflows in the vertical duct 92 disposed under the air-intake blower 91. The air flowing into the vertical duct 92 flows downward, and then flows to the horizontal duct 93 connected at the bottom of the vertical duct 92.

As shown in FIG. 21, the heat sink 13 is present in the horizontal duct 93. Therefore, the heat sink 13 can be cooled by the air flowing in the horizontal duct 93. By cooling the heat sink 13, the DMD 12 can be cooled effectively and efficiently, by which high temperature of the DMD 12 can be prevented.

The air flowing through the horizontal duct 93 flows into the pass-through area 65 (duct 65) or the opening 65a disposed for the light-source bracket 62 of the light source unit 60 (FIG. 4). The air flowing into the opening 65a flows through a space between the openably closable cover 54 and the light-source bracket 62, and cools the openably closable cover 54.

Meanwhile, the air flowing into the pass-through area 65 cools the light-source bracket 62, and then flows into a space opposite the light exit side of the light source 61 to cool a face of a reflector 67 so that the reflector 67 of the light source 61 is cooled, in which the face of the reflector 67 cooled by the air is a face opposite the reflection face of the reflector 67. Therefore, the air that passes through the pass-through area 65 can take heat from both of the light-source bracket 62 and the light source 61.

The air, which has passed near the reflector 67, passes through an exhaust duct 94, which is used to guide the air from the top side of the light-source bracket 62 to the lower side of the exhaust fan 86, and then converges into the air exhausted from the light-source air exhaust port 64c, and then flows to the exhaust port 85, and then the air can be exhausted from the exhaust port 85 using the exhaust fan 86.

Further, the air flowing into a space between the openably closable cover 54 and the light-source bracket 62 through the opening 65a cools the openably closable cover 54, and then flows inside the projector 1, and is then exhausted from the exhaust port 85 using the exhaust fan 86.

In an example embodiment, the transparent glass 51 is disposed on the upper face of the projector 1 as an exit window, from which the projected image P is projected onto the screen. Therefore, if the projector 1 is disposed near a window W, light from outside such as sunlight may enter inside the projector 1 through the transparent glass 51 as shown in FIG. 22.

FIG. 23 shows an example of a light path of an outside light entering the projector 1 through the transparent glass 51. As shown in FIG. 23, the outside light entering the projector 1 through the transparent glass 51 reflects, for example, on the curved mirror 42, and then strikes the free mirror bracket 44 retaining the curved mirror 42, the mirror bracket 43 retaining the reflection mirror 41, and the mirror holder 45 retaining the free mirror bracket 44 and the mirror bracket 43. Further, the outside light may enter inside the lighting unit 20 via the curved mirror 42, the reflection mirror 41, and the first optical system 70 configured with a plurality of lenses, and then strikes the light shield plate 263 retaining the DMD 12 and the concave mirror 25.

The outside light such as the sunlight includes visible light such as infrared (IR) rays and ultraviolet (UV) rays. In view of the weight reduction of the projector 1, the free mirror bracket 44, the mirror bracket 43, the mirror holder 45, and the light shield plate 263, retaining optical elements such as mirrors, may be made of resin material. However, the free mirror bracket 44, the mirror bracket 43, the mirror holder 45 and the light shield plate 263 made of the resin material may be vulnerable to the outside light including the UV rays and the IR rays when the outside light strikes the free mirror bracket 44, the mirror bracket 43, the mirror holder 45, and the light shield plate 263. When struck by the outside light, the UV rays degrades the free mirror bracket 44, the mirror bracket 43, the mirror holder 45, and the light shield plate 263, by which cracks may occur, mechanical strength may deteriorate, and damages may occur. Further, the IR rays may heat and deform the free mirror bracket 44, the mirror bracket 43, the mirror holder 45, and the light shield plate 263, which retains optical elements such as mirrors. If the cracks, damages, or deformation occur to the free mirror bracket 44, the mirror bracket 43, the mirror holder 45, and the light shield plate 263, the positions of the optical elements such as minors may be deviated, by which a projected image quality deteriorates.

Further, if the lens used for the projection lens unit 31 is made of resin material, the UV rays included in the outside light may degrade the lens.

In example embodiments, the invisible light such as the UV rays and IR rays included in the outside light can be blocked so that the UV rays and IR rays do not enter inside the projector 1. A description is given of detail of a configuration to block the invisible light.

### First Example Embodiment

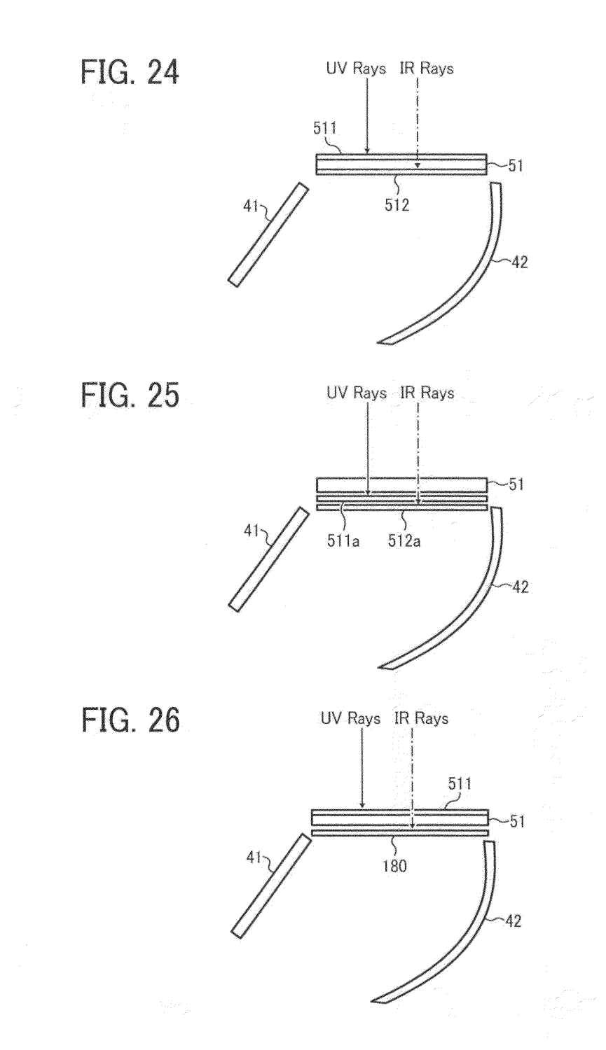

FIG. 24 shows a schematic configuration around the transparent glass 51 of the projector 1 of a first example embodiment. As shown in FIG. 24, the transparent glass 51 includes an invisible-light reduction device, which may be configured, for example, with a first invisible light reduction member such as a UV cut coat 511 and a second invisible light reduction member such as an IR cut coat 512. For example, the UV cut coat 511 is coated on the outer face of the transparent glass 51, and the IR cut coat 512 is coated on the inner face of the transparent glass 51, wherein the outer face of the transparent glass 51 faces the screen that is the outside of the projector 1, and the inner face of the transparent glass 51 faces the curved mirror 42 that is the inside of the projector 1. As above described, the transparent glass 51 includes two faces used for passing an projected image, one for the outside of the projector 1 or a screen side, and one for the inside of the projector 1 or the curved mirror 42 side. The UV cut coat 511 and the IR cut coat 512 can be coated on the transparent glass 51 using a vapor deposition or the like.

As above described, by coating the UV cut coat 511 and the IR cut coat 512 on the transparent glass 51, intrusion of UV rays and IR rays inside the projector 1 can be suppressed, in particular prevented. With this configuration, the radiation of UV rays and IR rays onto the free mirror bracket 44, the mirror bracket 43, the mirror holder 45, and the light shield plate 263 can be prevented, by which the deterioration and/or heat-caused deformation of the members can be suppressed. Further, because visible light can pass through the transparent glass 51, a projected image can be projected onto the screen, which means the transparent glass 51 does not block the passing of visible light.

In a configuration shown in FIG. 24, the UV cut coat 511 is coated on one face of the transparent glass 51, and the IR cut coat 512 is coated on other face of the transparent glass 51. Using the vapor deposition, the UV cut coat 511 can be coated on one face of the transparent glass 51, and the IR cut coat 512 can be coated on other face of the transparent glass 51 easily. Alternatively, the IR cut coat 512 and the UV cut coat 511 can be coated on the same one face of the transparent glass 51. Further, an UV cut film and an IR cut film can be adhered on the transparent glass 51. For example, as shown in FIG. 25, an UV cut film 511a and an IR cut film 512a can be stacked on the inner face of the transparent glass 51, which is opposite the outer face of the transparent glass 51 from which an image passes through and is projected.

### Second Example Embodiment

FIG. 26 shows a schematic configuration around the transparent glass 51 of the projector 1 of a second example embodiment. As shown in FIG. 26, a shutter 180 is disposed near the transparent glass 51 to block the light from outside. In the first example embodiment, the IR cut coat 512 may be heated by the IR rays included in the outside light, by which heat-caused deformation may occur to the transparent glass 51. If the transparent glass 51 deforms by heat, an image having good enough quality may not be projected onto the screen. In the second example embodiment 2, the transparent glass 51 is coated with the UV cut coat 511, and the shutter 180 is used to block the intrusion of IR rays.

As shown in FIG. 26, the shutter 180 is, for example, disposed at a position facing the inner face of the transparent glass 51, and the shutter 180 can be moved using a rack-and-pinion mechanism, in which the shutter 180 can be moved from a light block position facing the transparent glass 51 to a retracted position and vice versa. The shutter 180 can be made of, for example, a metal having higher heat conductivity.

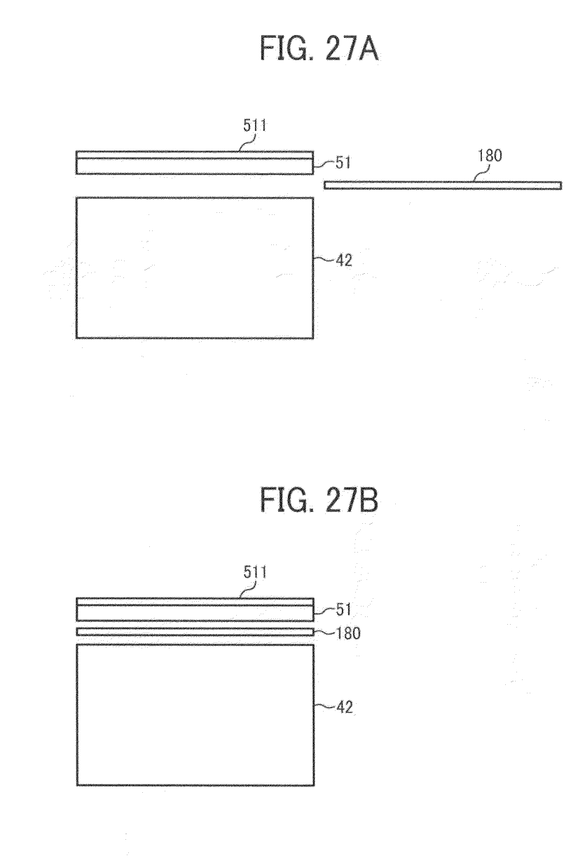

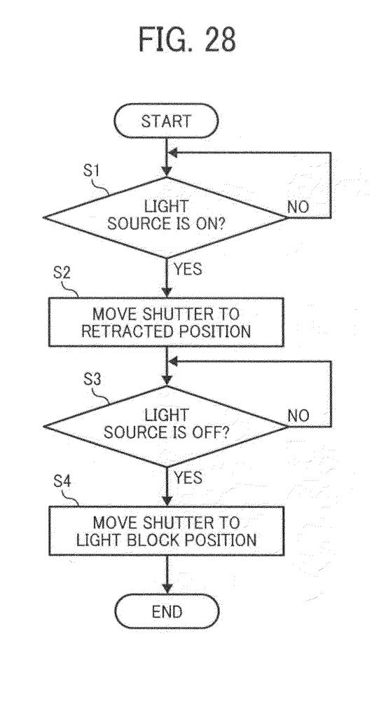

FIGS. 27A and 27B show a movement of the shutter 180 viewed from the reflection mirror 41 side, and FIG. 28 show a flowchart of a process of controlling the movement of the shutter 180. When the power-supply to the projector 1 is OFF, the shutter 180 is set at the light block position as shown in FIG. 27B to prevent the intrusion of the light from outside.

When the power-supply to the projector 1 is ON and the light source 61 is ON (S1: YES), a controller such as a processing circuit drives a drive motor to move the shutter 180 from the light block position show in FIG. 27B to the retracted position shown in FIG. 27A (S2). With this configuration, an image can be projected onto the screen via the transparent glass 51. Because the transparent glass 51 is coated with the UV cut coat 511, the intrusion of UV rays inside the projector 1 can be prevented when images are being projected onto the screen, and the deterioration of the free mirror bracket 44, the mirror bracket 43, the mirror holder 45, and the light shield plate 263 can be suppressed.

When the power-supply to the light source 61 is OFF (S3), and the image projection ends, the controller drives the drive motor to move the shutter 180 from the retracted position shown in FIG. 27A to the light block position shown in FIG. 27B (S4). With this configuration, the intrusion of IR rays inside the projector 1 can be prevented, and heat-caused deformation of the free mirror bracket 44, the mirror bracket 43, the mirror holder 45, and the light shield plate 263 can be suppressed, in particular prevented. Further, the shutter 180, which may be made of a metal or the like having higher heat conductivity can dissipate the heat, and thereby the heat radiation of the shutter 180 to the transparent glass 51 can be suppressed, and heating of the transparent glass 51 can be suppressed.

In the above described example embodiment, an image is generated using the image generator such as the DMD 12 and the projection optical apparatus such as the projection optical system B projects the image onto the projection face 101 by passing through the image light via a plurality of optical elements and the transparent glass 51 used as the exit window. The projection optical system B may be configured with the first optical unit 30 and the second optical unit 40. The projection optical system B is provided with the invisible light reduction member such as the UV cut coat 511 and the IR cut coat 512 that can cut invisible light to reduce, in particular, prevent the intrusion of the invisible light inside the projector 1. With this configuration, the effect of invisible light coming from outside to parts disposed inside the projector 1 can be suppressed. Further, because visible light are not cut by the invisible light reduction member, the image light can be projected on the projection face 101 without an effect of the invisible light reduction member, and images having good enough quality can be projected on the projection face 101.

In the above described example embodiment, as for the projection optical system B used as the projection optical apparatus, the invisible light reduction members can be disposed on the same face of the transparent glass 51 used as the exit window, or one invisible light reduction member is disposed on one face of the transparent glass 51 that passes the image light and other one invisible light reduction member is disposed on other face of the transparent glass 51 that passes the image light, which are the opposite faces. With this configuration, the intrusion of invisible light inside the projector 1 can be prevented.

Further, in the above described example embodiment, in the projection optical apparatus such as the projection optical system B, the first invisible light reduction member can cut UV rays. With this configuration, deterioration of parts made of resin material and disposed inside the projector 1 can be suppressed.

Further, in the above described example embodiment, in the projection optical apparatus such as the projection optical system B, the second invisible light reduction member can cut IR rays. With this configuration, heat-caused deformation of parts inside the projector 1 can be suppressed.

Further, in the above described example embodiment, in the projection optical apparatus such as the projection optical system B, the shutter 180 used as a shutter mechanism is disposed near the exit window of the transparent glass 51 to block the light coming from the outside. With this configuration, IR rays and/or UV rays can be blocked, and heat-caused deformation of the exit window of the transparent glass 51 can be suppressed.

Further, in the above described example embodiment, a projection lens and a concave mirror are disposed in the projection optical apparatus such as the projection optical system B. With this configuration, a projected image can be enlarged and projected onto the projection face 101.

Further, the above described projection optical apparatus can be employed for an image projection apparatus. The projection optical apparatus includes the light source 61, the image generator such as the DMD 12 that generates an image using the light emitted from the light source 61, and the above described projection optical apparatus such as the projection optical system B having a plurality of optical elements to project the image light onto the projection face. With this configuration, the effect of the outside-origin invisible light to the parts inside the image projection apparatus can be suppressed.

Further, as for the above described image projection apparatus such as the projector 1, the transparent glass 51 used as the exit window is disposed on an upper part of a casing of the image projection apparatus. With this configuration, the length of the image projection apparatus perpendicular to the projection face can become small.

In the above described example embodiment, the effect of invisible light from outside to internal parts of the projection optical apparatus and the image projection apparatus can be suppressed effectively.

In the above described example embodiment, the invisible light reduction member that can cut invisible light is disposed to suppress, in particular prevent, the entering of the outside invisible light into the apparatus. With this configuration, the effect of outside invisible light to internal parts in the apparatus can be suppressed, in particular prevented. Further, because the invisible light reduction member does not cut visible light, the image can be projected on the projection face without an effect of the invisible light reduction member.

What is claimed is:

1. A projection optical apparatus for projecting an image generated by an image generator by passing the image through a plurality of optical elements and an exit window of an image projection apparatus, the projection optical apparatus comprising:
an invisible-light reduction device to cut invisible light,
wherein the invisible-light reduction device prevents intrusion of the invisible light into the projection optical apparatus.

2. The projection optical apparatus of claim 1, wherein the invisible-light reduction device includes a first invisible-light reduction member and a second invisible-light reduction member,
wherein the first and second invisible-light reduction members are disposed on the same face of the exit window, or
wherein the first invisible-light reduction member are disposed on a first face of the exit window and the second invisible-light reduction member is disposed on a second face of the exit window opposite the first face.

3. The projection optical apparatus of claim 2, wherein the first invisible-light reduction member cuts ultraviolet (UV) rays.

4. The projection optical apparatus of claim 2, wherein the second invisible-light reduction member cuts infrared (IR) rays.

5. The projection optical apparatus of claim 3, further comprising a shutter disposed near the exit window to block light from outside the apparatus.

6. The projection optical apparatus of claim 1, further comprising:
a projection lens; and a curved mirror.

7. An image projection apparatus, comprising:
a casing;
a light source disposed within the casing;
an image generator disposed within the casing to generate an image using light emitted from the light source; and
the projection optical apparatus of claim 1, having a plurality of optical elements with which to project the image.

8. The image projection apparatus of claim 7, wherein the exit window is disposed on an upper part of the casing.
